(19) United States
(12) Patent Application Publication
(10) Pub. No.: US 2008/0290824 A1
(43) Pub. Date: Nov. 27, 2008

(54) APPARATUS AND METHOD FOR CONTROLLING OPERATION OF MOTOR

(75) Inventors: Jae-Hak Choi, Seoul (KR); Sung-Ho Lee, Seoul (KR); Jin-Soo Park, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/935,010

(22) Filed: Nov. 5, 2007

(30) Foreign Application Priority Data
May 25, 2007 (KR) 10-2007-0051093

(51) Int. Cl. H02P 4/00; H02P 27/06

(52) U.S. Cl. 318/139; 318/770

(57) ABSTRACT

An apparatus for controlling a motor includes an inverter to convert a DC voltage into an AC voltage, a power selecting circuit to select external power or power from the inverter, and a controller to control operation of the power selecting circuit according to a load of the motor.

### BACKGROUND

1. Field

One or more embodiments disclosed herein relate to motors.

2. Background

An induction motor operates based on the principle that when current flows in a wire in a magnetic field, power is generated from the wire according to Flemming's left-hand rule. And, when the magnetic field is a rotational magnetic field, current is generated at one or more conductive bars within the rotor based on Faraday's Law.

The flow of current in the wire (e.g., a coil winding) causes a force to be applied to the bars in the rotor. This force is converted into a rotary force to drive a shaft of the motor. However, the maximum rotational speed that an induction motor is able to achieve is limited by various factors.

### BRIEF DESCRIPTION OF THE DRAWINGS

FIG. 1 is a diagram showing one embodiment of an apparatus for controlling a motor;

FIG. 2 is a diagram showing steps included in one embodiment of a method for controlling operation of a motor;

FIG. 3 is a diagram showing another embodiment of an apparatus for controlling a motor;

FIG. 4 is a diagram showing steps included in another embodiment of a method for controlling operation of a motor; and

FIG. 5 is a diagram showing one embodiment of an appliance that may include any of the aforementioned apparatuses or that may perform of the aforementioned methods.

### DETAILED DESCRIPTION

When a rotational magnetic field is applied in an induction motor, a rotor containing one or more conductive bars begins to rotate. When the rotational speed of the rotor reaches a synchronous speed that corresponds to a rotational speed of the magnetic field, induction current may not be generated and thus the torque for rotating the rotor may become zero. Hence, the rotor may rotate at speeds lower than the synchronous speed of the rotational magnetic field.

As an example, consider the case where an AC current of 60 Hz (i.e., a general AC frequency) is applied and a 2-pole motor is used. Under these circumstances, the synchronous speed is 3,600 rpm (revolution per minute), which is computed by 120×(frequency)/(the number of poles). However, the maximum rotational speed of the motor may be about 3,000 rpm, which is smaller than the synchronous speed of 3,600 rpm.

A self-magnetizing motor (SMM) is one variation of an induction-type motor that has magnetic material disposed on a rotor containing one or more conductive bars. An SMM motor operates as an induction motor until the speed of the rotor approaches near or reaches the synchronous speed of the rotational magnetic field. At this time, the magnetic material on the rotor is excited to cause the motor to operate as a permanent magnet motor. Operating in this mode, the rotational speed of the motor can be increased to synchronous speed of the rotational magnetic field, which is a speed that would not be possible if the motor exhibited the characteristics of a pure induction motor.

In order to vary the speed of the rotor, the size of the applied voltage may be controlled and the number of poles may be converted within the SMM. In order to vary the speed, the stator may be wound and a variable resistor may be installed at the excitation coil to control the size of the applied voltage and speed of the motor by converting the number of poles. However, when an attempt is made to convert speed and the number of poles in a small to medium size motor is made, the variable speed range may be limited, which may cause degradation in operation efficiency.

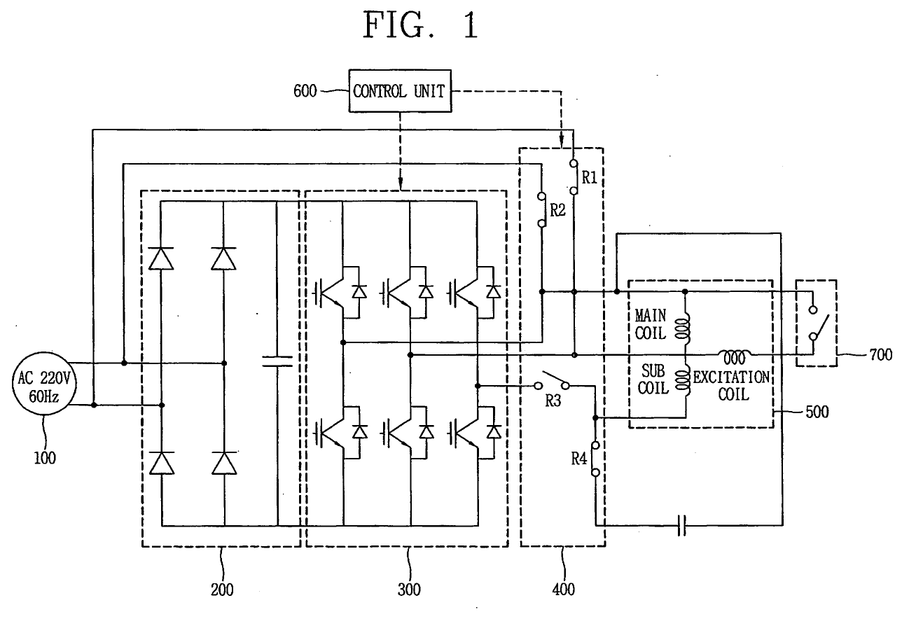

FIG. 1 shows one embodiment of an apparatus for controlling operation of a motor, which, for example, can be an SMM motor or another induction-type motor. As shown in FIG. 1, the apparatus includes a main coil, a sub-coil, an excitation coil, a power source 100, a rectifying and smoothing circuit 200, an inverter 300, a power selecting circuit or selector 400, a self-excitation motor 500, a control unit or controller 600, and an excitation switch 700.

The power source 100 may be any type of power from an external source that, for example, may be a power source such as obtained from a wall socket or outlet (e.g., 220 V or 120 V) provided by a power company, a power generator, or a fuel cell or battery. The rectifying and smoothing unit 200 rectifies and smoothes the external power supplied from the power source to generate a DC voltage. The inverter 300 converts the DC voltage from the rectifying and smoothing unit into an AC voltage of a certain frequency. The inverter may have a full-bridge topology; however, a half-bridge, push-pull, or other type of inverter topology may be used in alternative embodiments.

The power selecting circuit or selector 400 selects the external power or the AC voltage from the inverter based, for example, on the current load of the motor. The power selecting circuit may make this selection based on control signals generated from a controller (e.g., controller 600) used to manage operation of the motor in order to achieve an intended application. According to one non-limiting embodiment, the motor may be installed in an appliance such as but not limited to a refrigerator. The selected power source (i.e., external power or AC voltage from the inverter) is then applied to a coil section 500 of the motor.

As an example, the power selecting unit 400 may include first to fourth relays R1 to R4, which are switched in different configurations to connect and disconnect the coil section to receive the external power or AC power from the inverter. The coil section may include, for example, a main coil and a sub-coil formed from windings that are fixed around teeth of a stator of the motor. The teeth that include the main coil windings may be longer than the teeth that include the sub-coil windings.

The excitation switch 700 is switched which controls the supply of external power to the excitation coil during a certain time period, to be described in greater detail below. The excitation switch may, for example, be a bi-directional power semiconductor device such as a triac or a relay.

The control unit 600 controls operation of the power selecting unit according to a detected load, and also controls the switching operation of the excitation switch. According to one embodiment, when a predetermined excitation input time arrives, control unit 600 generates a control signal for turning on excitation switch 700. Turning on this switch connects the excitation coil to the external power source when the relays in the power selecting circuit are configured in a specific manner. As a result, the magnetic material on the rotor is excited.

When the predetermined excitation time lapses, the control unit generates a control signal to turn off the excitation switch. However, the magnetic material on the rotor remains magnetized at substantially the same levels. As a result of excitation of the magnetic material, an electric field which, when combined with the field generated from the main and sub-coils, enhances the operational speed capability of the motor. Various phases of operation of the motor will now be discussed.

When the motor is started, the control unit generates one or more signals for applying external power to the main and sub-coils. The magnetic material is then excited. Then, the current load of the motor is determined and compared to a pre-set reference load.

If the current load is larger than the pre-set reference load, control unit 600 generates signals to cause external power to be applied to the main coil and sub-coil. If the current load is smaller than the pre-set reference load, control unit 600 generates signals to cause the AC voltage from the inverter to be applied to the main and sub-coils.

In this case, the control unit controls the switching of the transistors in the inverter based on a level of a reduced speed. Controlling switching in this manner causes the operating frequency of the AC voltage from the inverter to be set to a desired value, which, for example, may correspond to a desired reduced speed. The resulting AC voltage with the set operating frequency is then applied to the main and sub-coils.

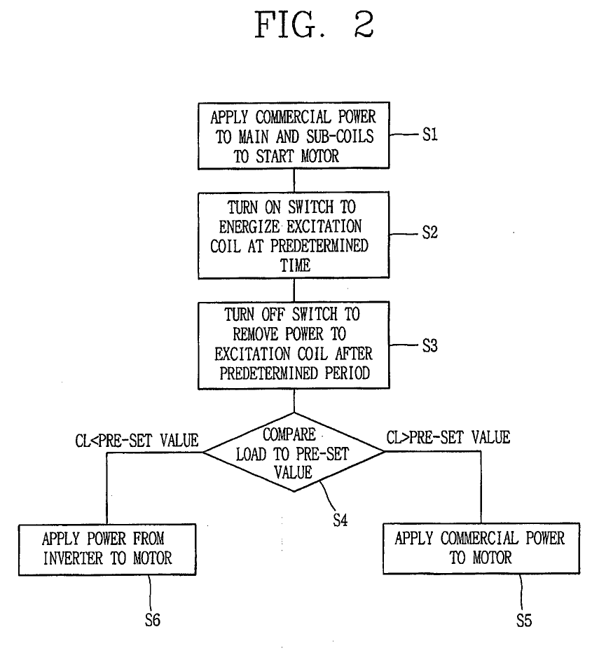

Operation of the apparatus shown in FIG. 1 will now be described with reference to the steps set forth in FIG. 2.

First, to start the motor, control unit 600 controls the power selecting unit 400 to apply external power to the main and sub-coils of the motor (S1). In response to the control unit, the switches in the power selecting unit assume a configuration which applies external power from the power source unit 100 to the main and sub-coils of the self-excitation motor. The application of this power may be achieved, for example, by closing the first, second, and fourth relays R1, R2, and R4 and opening the third relay R3. Accordingly, the self-excitation motor is started by the external power (frequency).

Next, the excitation coil is energized. More specifically, when a predetermined excitation input time arrives, control unit 400 generates a signal to turn on excitation switch 700 (S2). When the predetermined excitation time lapses, the control unit generates a signal to turn off the excitation switch (S3). The predetermined excitation input time may be a time value stored in a control memory associated with the motor.

Preferably, the control unit causes an excitation current to be applied from the external power unit 100 to the excitation coil for a predetermined period of time. This predetermined time may, for example, be in the range of 1 to 10 cycles (e.g., rotations) of the rotor, with a 1 to 5 cycle time being preferable. In other embodiments, a different time may be used. When switch 700 is closed, the external power energizes the excitation coil, which, in turn, excites magnetic material (e.g., Neodymium or ferrite) on the rotor. As a result, a supplemental magnetic field is created within the motor which combines with the magnetic flux produced from the main and sub-coils to convert the SMM into a permanent magnet mode of operation of the motor.

At this time, in the power selecting unit 400, the first, second and fourth relays R1, R2, and R4 may be closed while the third relay R3 is opened under the control of the control unit 600. In this case, the self-excitation motor may now operate at synchronous speed (e.g., 3,600 RPM) of 100% rated capability by the external power. Next, the current load of the motor is compared to a pre-set reference value (S4).

If the current load is greater than the pre-set reference load (namely, a high-speed command has been generated by control software or circuitry), control unit 600 controls power selecting unit 400 to apply external power output from the power source unit 100 to the main and sub-coils of the motor (S5). Accordingly, the self-excitation motor will be capable of operating at synchronous speed (e.g., 3,600 RPM) of the rated capability by the external power. At this time, in the power selecting unit 400, the first, second and fourth relays R1, R2, and R4 are closed while the third relay R3 is opened under the control of the control unit 600.

If the current load is smaller than the pre-set reference load (namely, a low speed or speed reduction command has been generated by control software or circuitry), control unit 600 controls switching of the power selecting unit so that AC voltage from inverter 300 will be applied to the main and sub-coils of the motor (S6). With power from the inverter applied, the control unit varies the operational frequency of an AC voltage output from the inverter based on a level of the reduced speed, to thereby reduce the rotational speed of the motor proportionally.

Accordingly, the self-excitation motor rotates at a speed of less than 100% rated capability when AC voltage (with frequencies varied by the inverter) is applied to the main and sub-coils from the inverter. As a result, the motor achieves rotational speeds that are less than 3,600 RPM, which speeds may be previously set according, for example, to the size of the load that is measured. At this time, in the power selecting unit 400, the third relay R3 may be closed while the first, second and fourth relays R1, R2, and R4 may be opened under the control of the control unit 600.

Thus, according to the embodiments of FIGS. 1 and 2, the rotational speed of the motor may be enhanced by selectively applying external power or AC power from the inverter to the main and sub-coils of the motor, after a time when magnetic material on the rotor is excited by the external power.

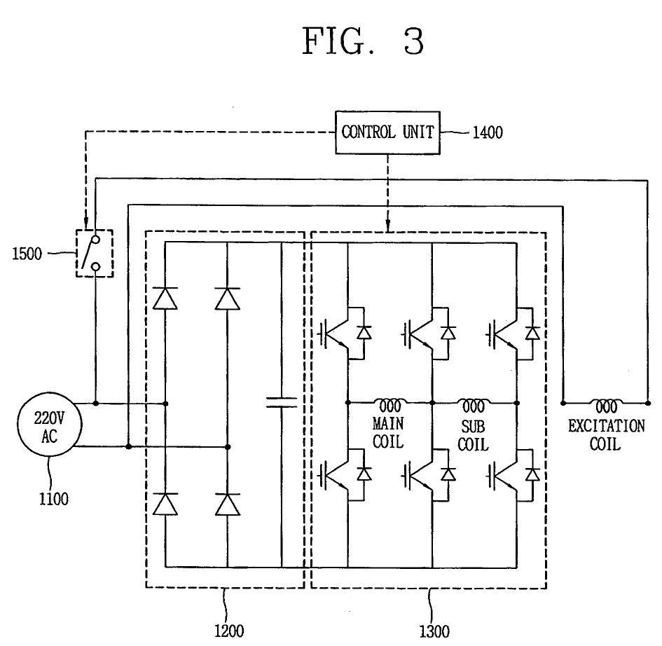

FIG. 3 shows another embodiment of an apparatus for controlling operation of a motor, which for example, may be an induction-type motor such as an SMM. This apparatus includes a main coil, a sub-coil, an excitation coil, a power source unit 1100, a rectifying and smoothing unit 1200, an inverter 1300, a self-excitation motor (not shown), a control unit 1400, and an excitation switch 1500.

The power source unit 1100 may be the same as unit 100 in FIG. 1.

The rectifying and smoothing unit 1200 rectifies and smoothes external power supplied from power source unit 100 to generate a DC voltage.

The inverter 1300 converts the DC voltage from the rectifying and smoothing unit 1200 into an AC voltage of a certain frequency.

The excitation switch 1500 may be configured to apply external power to the excitation coil during a certain time period.

The control unit 1400 controls frequency conversion of the AC voltage output from the inverter 1300 according to a current load condition. The control unit also controls a switching operation of the excitation switch 1500 in order to excite a magnetic material on the rotor when a certain time lapses after the self-excitation motor is started. More specifically, when a predetermined excitation input time arrives, the control unit turns on the excitation switch and turns off this switch when the predetermined excitation time elapses.

To start the motor, the control unit generates one or more signals to cause AC voltage from the inverter 1300 to be applied to the main and sub-coils of the motor. Accordingly, the motor is started at a low speed. The magnetic material on the rotor is then excited, after which a current load on the motor is measured.

If the current load is greater than a pre-set reference load, control unit 1400 adjusts (e.g., increases) the frequency of the AC voltage output from the inverter and applies this voltage and the adjusted frequency to the main and sub-coils. If the current load is smaller than the pre-set reference load, the control unit adjusts (e.g., reduces) the frequency of the AC voltage output from the inverter and applies the resulting voltage at the adjusted frequency to the main and sub-coils.

More specifically, the control unit 1400 controls switching of the inverter based on a level of the increased or decreased speed, and accordingly the operation frequency of the AC voltage output from the inverter is varied and controlled to be applied to the main and sub-coils of the motor.

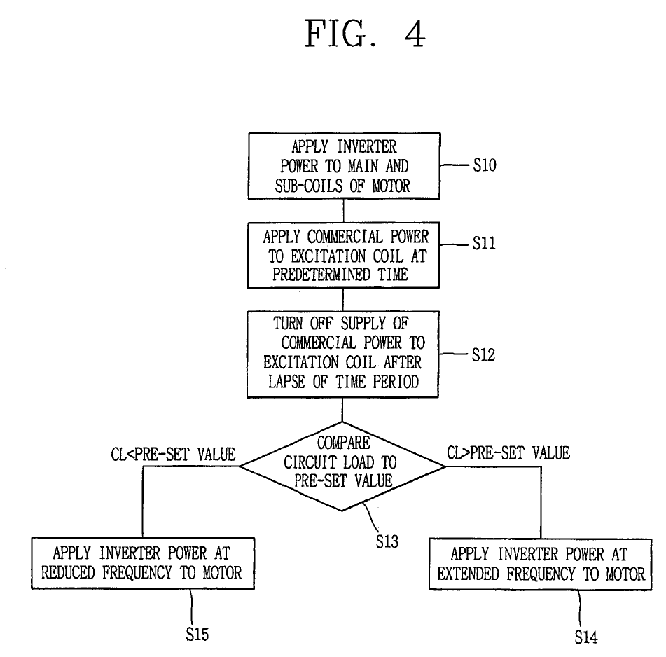

Operation of the apparatus of FIG. 3 will now be explained with reference to the steps in FIG. 4. First, AC voltage from the inverter is applied as it is to the main and sub-coils of the motor (S10). Accordingly, the self-excitation motor is started.

Next, when the predetermined excitation input time arrives, the control unit 1400 generates one or more signals for turning on the excitation switch 1500, to thereby cause external power to be applied to the excitation coil (S11). Then, when a predetermined excitation time lapses (e.g., 1 to 10 cycles of rotation of the rotor, with 1 to 5 cycles being preferable), the control unit turns off the excitation switch to cut off external power to the excitation coil (S12). As a result of these steps, magnetic material on the rotor is now in an excited state, which state remains with substantially now reduction in strength after the excitation switch is cut off.

After the magnetic material is excited, the current load on the motor is measured and compared to a pre-set reference load (S13). If the current load is greater than the pre-set reference load (namely, high speed command), the control unit controls the switching of the inverter to apply an AC voltage signal at an extended frequency to the main coil and the sub-coil of the excitation motor. Accordingly, the motor is rotated at a synchronous speed (e.g., maximum 3,600 RPM) by the AC voltage output from the inverter (S14).

If the current load is smaller than the pre-set reference load (namely, a speed reduction command), the control unit controls the switching of the inverter to apply an AC voltage signal at a reduced frequency to the main and sub-coils of the motor. The control unit may vary the operational frequency of the AC voltage output from the inverter based on a level of increased or decreased speed, to proportionally increase or decrease the rotational speed of the motor (S15).

Accordingly, the motor rotates at a speed of less than the rated 100% capability by based on the AC voltage (with frequencies varied by the inverter) output from the inverter. This speed is less than synchronous speed, e.g., less than 3,600 RPM, which may be previously set according to load.

Thus, in accordance with one or more of the foregoing embodiments, external power and power output from an inverter may be selectively applied to an induction-type motor to extend the range of the motor to achieve enhanced rotational speed, improve efficient control, or both. Additionally, in order to achieve this enhanced speeds, magnetic material on the rotor may be excited by external power, while the main and sub-coils of the motor may be energized by external power or power output from the inverter.

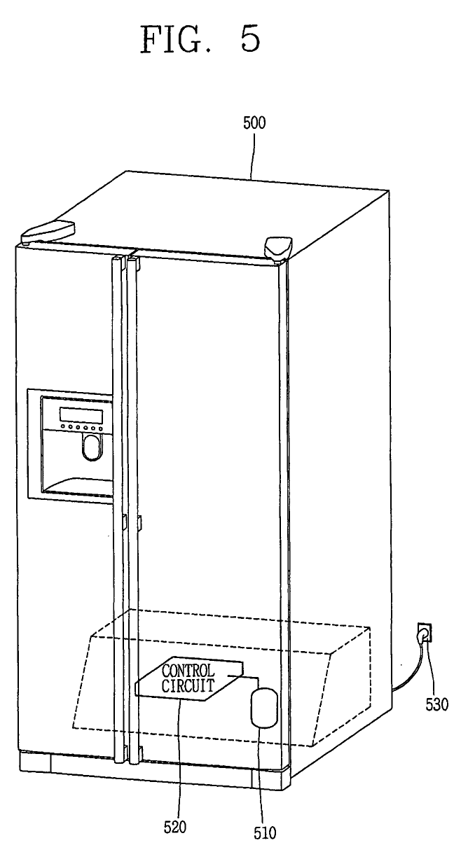

FIG. 5 shows an appliance that may include any of the embodiments of the apparatuses and/or which may perform the steps of the methods previously discussed. In FIG. 5, the appliance is shown as a refrigerator 500. However, other appliances such as but not limited to washing machines, dish washers, air conditioners, or any other motor drive device may include the embodiments discussed herein.

When incorporated into a refrigerator, the motor 510 may be used to drive a compressor or another part of the refrigerator. The motor may be controlled by a control circuit 520, which may correspond to any of the apparatuses previously described herein. When implemented in this manner, the control circuit may control the supply of power to the motor. In so doing, the external power to be applied to the excitation coil and alternatively to the main and sub-coils may be derived from a wall outlet 530.

Further, details of a compressor having a self-magnetizing motor can be found in U.S. application Ser. Nos. 11/898,389 filed on Sep. 12, 2007, and 11/866,920 filed on Oct. 3, 2007, and Korean Application Nos. 10-2007-0021664 filed Mar. 5, 2007 and 10-2007-45698 filed May 10, 2007, the entire disclosures of which are incorporated herein by reference.

As so far described, the foregoing embodiments of the apparatus and method may therefore have one or more the following advantages. First, because the speed variable width of the self-excitation motor is increased by using the inverter, the operation efficiency of the self-excitation motor can be improved. Second, because the magnetic material is excited by external power, shortcomings associated with device capacity increasing when the magnetic material on the rotor is excited through the inverter can be solved, and thus implementation costs can be reduced.

In accordance with one embodiment, an apparatus for controlling an operation of a motor that may include: an inverter that converts a DC voltage into an AC voltage with a certain varied voltage (an AC voltage that has been varied by certain frequencies); a power selecting unit that selects external power or an AC voltage outputted from an inverter and applies the selected one to a motor; and a control unit that controls an operation of the power selecting unit according to a load.

In accordance with one or more embodiments, the apparatus may further include: a rectifying and smoothing unit that rectifies and smoothes external power; an inverter that converts a DC voltage outputted from the rectifying and smoothing unit into an AC voltage with a certain varied frequency; a power selecting unit that selects the external power or an AC voltage outputted from the inverter and applying the selected one to the motor; an excitation switch that switches to apply the external power to an excitation coil during a certain time period; and a control unit that controls an operation of the power selecting unit and a switching operation of the excitation switch.

In accordance with one or more embodiments, an inverter may converts a DC voltage into an AC voltage with a certain varied frequency; a motor that includes a main coil, a sub-coil (auxiliary coil) and an excitation coil wound on a stator and is driven by the AC voltage outputted from the inverter; an excitation switch that switches to apply external power to the excitation coil during a certain time period; and a control unit that controls a switching operation of the excitation switch.

In accordance with another embodiment, a method for controlling an operation of a motor that may include: starting a motor with external power; converting a DC voltage into an AC voltage with a certain varied frequency; and selecting the external power or the AC voltage according to a load and applying the selected one to the motor.

One or more embodiments may include the additional steps of starting a motor with external power; applying the external power to an excitation coil during a certain time period to excite a magnetic material; rectifying and smoothing the external power and converting the smoothed DC voltage into an AC voltage; and selecting the external power or the AC voltage according to a load and applying the selected one to the motor.

In accordance with another embodiment, a method for controlling an operation of a motor that may include: rectifying and smoothing external power and converting the smoothed DC voltage into an AC voltage; starting a motor with the AC voltage; exciting the motor with the external power; and varying an operation frequency of the AC according to a load and operating the motor.

Any reference in this specification to “one embodiment,” “an embodiment,” “example embodiment,” etc., means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to effect such feature, structure or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for controlling an operation of a motor, comprising:
an inverter to convert a DC voltage into an AC voltage;
a power selecting circuit to select external power or power output from the inverter and to apply the selected power to the motor; and
a controller to control operation of the power selecting circuit according to a load of the motor.

2. The apparatus of claim 1, further comprising:
a switch to apply external power to an excitation coil of the motor for a predetermined time period.

3. The apparatus of claim 2, wherein the controller controls the switch to apply the external power to the excitation coil when a predetermined excitation input time arrives, and controls the switch to block application of the external power to the excitation coil when the predetermined excitation time elapses.

4. The apparatus of claim 1, wherein the controller causes the external power to be applied to a main coil and a sub-coil of the motor during a start-up time.

5. The apparatus of claim 1, wherein the controller causes the external power to be applied to a main coil and a sub-coil of the motor when a current load is greater than a pre-set reference load.

6. The apparatus of claim 1, wherein controller causes the power from the inverter to be applied to a main coil and a sub-coil of the motor when a current load is smaller than the pre-set reference load.

7. The apparatus of claim 6, wherein the controller sets an operational frequency of a power signal from the inverter and causes the power signal to be applied to a main coil and a sub-coil of the motor.

8. The apparatus of claim 1, wherein the external power is obtained from one of a power company, a power generator, a fuel cell, or a battery.

9. A method for controlling an operation of a motor, comprising:
starting a motor with external power;
converting a DC voltage to an AC voltage;
selecting the external power or the AC voltage according to a load of the motor; and
applying the selected external power or AC voltage to the motor.

10. The method of claim 9, further comprising:
applying the external power to an excitation coil to excite magnetic material coupled to a rotor of the motor.

11. The method of claim 9, wherein said applying includes applying the external power or AC voltage to at least one of a main coil or a sub-coil of the motor according to said load.

12. The method of claim 11, further comprising:
applying the external power to at least one of a main coil or a sub-coil of the motor when a current load is greater than a pre-set reference load; and
applying the AC voltage to at least one of the main or sub-coil of the motor when the current load is less than the pre-set reference load.

13. The method of claim 12, wherein applying the AC voltage comprises:
varying an operational frequency of the AC voltage based on a level of a reduced speed of the motor; and
applying the AC voltage with said varied operational frequency to at least one of the main coil or sub-coil of the motor.

14. The method of claim 9, wherein the external power is obtained from one of a power company, a power generator, a fuel cell, or a battery.

15. A method for controlling a motor, comprising:
applying power from a first power source to the motor; and
applying power from a second power source to the motor;
wherein power from the first power source or the second power source is selectively applied to a same coil of the motor for different modes of operation.

16. The method of claim 15, wherein the motor rotates within a first range of speeds during a first mode of operation and rotates within a second range of speeds during a second mode of operation.

17. The method of claim 16, wherein the first range of speeds includes a greater maximum speed than the second range of speeds.

18. The method of claim 17, wherein the first range of speeds includes a synchronous speed of the motor.

19. The method of claim 16, wherein the first power source is an external power source and the second power source includes an inverter coupled between the external power source and the motor.

20. The method of claim 19, wherein a rotational speed of the motor is based on a parameter of the external power source during the first mode of operation and is based on a frequency of a power signal output from the inverter during the second mode of operation.

21. The method of claim 15, further comprising:
starting the motor based on power from the first power source,
wherein power from the second power source is not applied when the motor is started.

22. The method of claim 15, further comprising:
applying power from the first power source to an excitation coil; and
applying power from the first power source or the second power source to the same coil of the motor based on a control signal.

23. The method of claim 22, wherein applying power from the first power source causes magnetic material in the motor to become excited, said excited magnetic material generating a supplemental magnetic field which, when added to the magnetic field generated by at least said same coil, allows the motor to achieve a synchronous speed during a high-speed mode of operation.

24. The method of claim 22, further comprising:
comparing a current load of the motor to a predetermined reference value; and
generating the control signal based on the comparison.

25. A method for controlling a motor, comprising:
applying power from a first power source to the motor; and
applying power from a second power source to the motor,
wherein power from the first and second power sources are applied to different coils of the motor and wherein the motor operates within a first range of rotational speeds before power is applied from the first power source and operates within a second range of rotational speeds after power is applied from the first power source.

26. The method of claim 25, wherein the second range of rotational speeds includes a higher maximum speed than the first range of rotational speeds.

27. The method of claim 25, wherein the second range of rotational speeds includes a synchronous speed of the motor.

28. The method of claim 25, wherein power from the first power source is applied to an excitation coil of the motor and power from the second power source is applied to at least a main coil of the motor.

29. The method of claim 25, wherein the first power source is an external power source and the second power source includes an inverter coupled between the external power source and the motor.

30. The method of claim 25, further comprising:
applying power from the first power source excites an excitation coil; and
shutting off power from the first power source to an excitation coil after a predetermined period of time has elapsed, wherein magnetic material is excited by power to the excitation coil to cause the motor to achieve the second range of rotational speeds having a higher maximum speed than the first range of rotational speeds.

31. The method of claim 25, further comprising:
controlling a speed of the motor based on a frequency of power from the second power source when the motor operates in each of the first range of rotational speeds and the second range of rotational speeds.

32. The method of claim 25, further comprising:
comparing a current load of the motor to a predetermined value; and
increasing a frequency of power from the second power source based on the comparison.

33. The method of claim 32, wherein said increasing includes:
setting the frequency to a value which causes the rotational speed of the motor to achieve a synchronous speed included within the second range of rotational speeds.

34. The method of claim 25, further comprising:
starting the motor by applying power from the second power source to at least a first coil of the motor before power from the first power source is applied to a second coil of the motor.

35. A refrigerator, comprising:
a motor; and
a controller to control the motor, said controller including:
an inverter to convert DC power into AC power;
a power selecting circuit to select external power or the AC power output from the inverter and to apply the selected power to the motor; and
a control circuit to control the power selecting circuit based on a load of the motor.
